(19) United States
(12) Patent Application Publication
(10) Pub. No.: US 2002/0159872 A1
(43) Pub. Date: Oct. 31, 2002

(54) Ceiling mounted delivery device for use inside of a motor vehicle

(76) Inventor: Douglas Dominic Scartelli, Bethlehem, PA (US)

Correspondence Address: Douglas D. Scartelli, 5000 Long Drive, Bethlehem, PA, 18020, US

(21) Appl. No.: 10/098,852

(22) Filed: Mar. 14, 2002

Related U.S. Application Data
(60) Provisional application No. 60/288,553, filed on Apr. 25, 2001.

(51) Int. Cl. B60R 5/00; B60R 27/00; B60P 1/00

(52) U.S. Cl. 414/542; 224/311

(57) ABSTRACT

A ceiling mounted delivery device for use inside of a motor vehicle is disclosed, and according to the present invention, is designed to allow the safe, controlled delivery of items between seated passengers who are separated by distances greater than their personal reach. There are two present versions of this invention. The first version consists of an aluminum flat metal frame that roughly runs the length of the vehicle's ceiling. A pulley is affixed just fore and aft of the frame and a nylon string connects both pulleys together forming a pulley type conveyor delivery system. As the conveyor nylon string is manually moved, personal items attached to the string are transported from one end of the device/vehicle to the other. This pulley type conveyor delivery system utilizes two flat metal cross members designed to hold said frame onto the ceiling of the vehicle. The second version utilizes a rotatable screw gear drive conveyor delivery system. The rotatable screw gear runs the length of said conveyor delivery system. This rotatable screw gear drive conveyor delivery system is held along the length of the ceiling by two flat metal cross members. As the screw gear is rotated, a screw gear shuttle rides the length of the gear thus transporting attached personal items from one end of said conveyor delivery system to the other.

I claim the benefit of filing date of Provisional Application No. 60/288,553 filed on Apr. 25, 2001.

### BACKGROUND OF THE INVENTION

1. Field of invention

The present invention relates generally to transporting devices and, more particularly, to a ceiling mounted delivery device for use inside of a motor vehicle.

2. Description of the Related Art

Throughout the years there has always been a need for motor vehicles to accommodate multiple passengers. The station wagon has, and continues to, meet this need. The market has also grown to include mini vans, passenger vans, and large sport utility vehicles. As our society continues to become increasingly mobile, the length and frequency of time the family spends in these types of vehicle increases.

Many times while inside of said vehicles, passengers desire to transfer items between and amongst each other. For sedan and station wagon type vehicles this is accomplished by manually passing items between the front and rear seats For owners of mini vans, passenger vans, large sport utility vehicles, and handicap accessible vehicles, it is often necessary to transfer items to each other separated by one or more row(s) of seats.

There are problems inherent in transferring items inside such types of vehicles where occupants are separated by one or more row(s) of seats. First (as it is almost impossible to manually pass items between these distances) passengers may decide to throw the item to a passenger seated in the rear most seat. This method of transfer is dangerous as the item may hit the passenger causing an injury. Second, throwing an item is not an accurate method of transferring items between passengers in this type of seating configuration. Third, passengers may decide to walk back and forth to each other to transfer the item(s). This method of transfer is dangerous as said passengers are unrestrained while in a moving vehicle.

Consequently, a need has been felt for providing an apparatus and method that overcomes the problems cited above.

SUMMARY OF THE INVENTION

It is therefore an object of the present invention to provide a ceiling mounted delivery device for use inside of a motor vehicle that allows the safe, controlled delivery of items between seated passengers who are separated by distances greater than their physical reach.

Briefly described according to one embodiment of the present invention, a ceiling mounted delivery device for use inside of a motor vehicle is disclosed, and is designed to transport items between passengers that are separated by distances greater than their physical reach. There are at least two versions of this invention.

The first version consists of aluminum flat bar metal/plastic frame conveyor that roughly runs the length of the vehicle ceiling. This flat bar metal frame utilizes two flat bar cross members designed to hold said conveyor onto the ceiling of the vehicle. A pulley is affixed just fore and aft of the frame and a nylon string connects both pulleys together forming a conveyor type delivery system. As the conveyor string is manually moved, personal items attached to the string are transported from one end of the device/vehicle to the other.

The second version utilizes a rotatable screw gear drive that roughly runs the length of the conveyor delivery system. This rotatable screw gear drive conveyor is held along the length of the ceiling by two flat bar crossmembers. As the screw gear is rotated, a screw gear shuttle rides the length of the gear thus transporting attached personal items from one end of the vehicle to the other.

It is another object of the present invention to provide a device that can be operated by one individual.

It is another object of the present invention to provide a device that can be easily mounted inside of a motor vehicle without making any modifications to the roof and headliner of said vehicle.

### Descriptive Key

a ceiling mounted delivery device for use inside of a motor vehicle

20 roof

30 headliner of roof

40 motor vehicle

50 front flat bar cross member

60 rear flat bar cross member

70 pulley conveyor frame

80 front pulley

85 rear pulley

90 nylon string

100 small metal plate

110 magnet sewn inside of nylon mesh shuttle bag

120 nylon mesh shuttle bag

130 Velcro closure

150 rotatable screw gear

160 screw gear shuttle bolt

170 magnetized metal plate

190 metal shuttle bolt stabilizer

200 screw gear housing

220 electric powered screw gear motor

230 on/off toggle switch

250 retaining nut and bolt assembly

260 mounting hole attachment sites to vehicle

270 screw gear conveyor frame

### BRIEF DESCRIPTION OF THE DRAWINGS

The advantages and features of the present versions of this invention will become better understood with reference to the following more detailed description and claims taken in conjunction with the accompanying drawings, in which like elements are identified with like symbols, and in which:

FIG. 1 is a view from below in perspective from a preferred embodiment of a ceiling mounted delivery device for use inside of a motor vehicle 10;

FIG. 2 is a left side view of the structure illustrated in FIG. 1; with the left side view being a mirror image of the right side view;

FIG. 3 is a front view;

FIG. 4 is a rear elevational view;

FIG. 5 is a left side view of an alternate embodiment of structure in accordance with the invention;

FIG. 6 is a perspective view of the preferred embodiment of the present invention in use.

### DESCRIPTION OF THE PREFERRED EMBODIMENTS

In order to describe the complete relationship of the invention, it is essential that some description be given to the manner and practice of functional utility and description of a ceiling mounted delivery device for use inside of a motor vehicle 10.

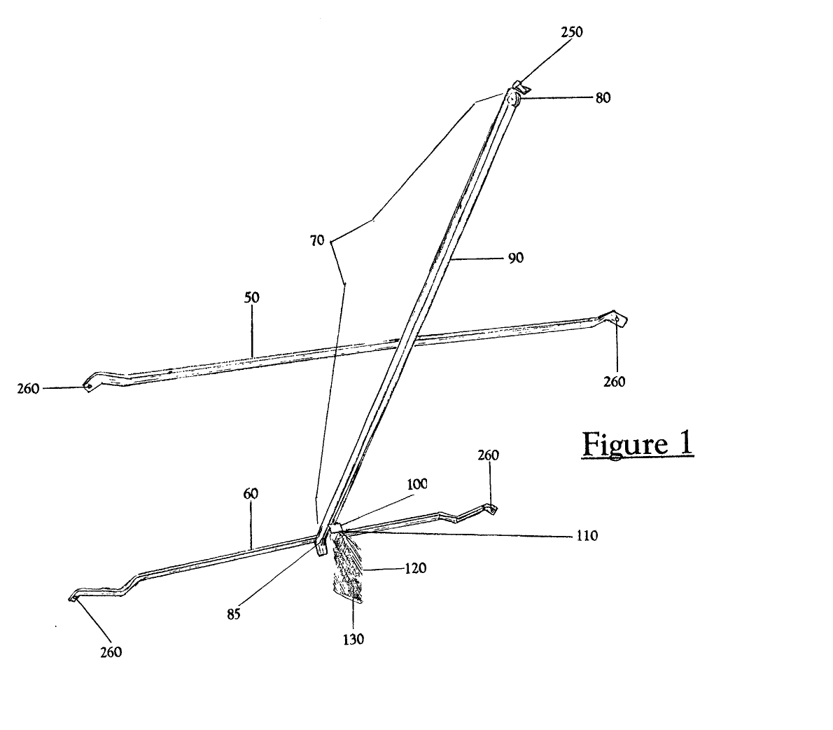

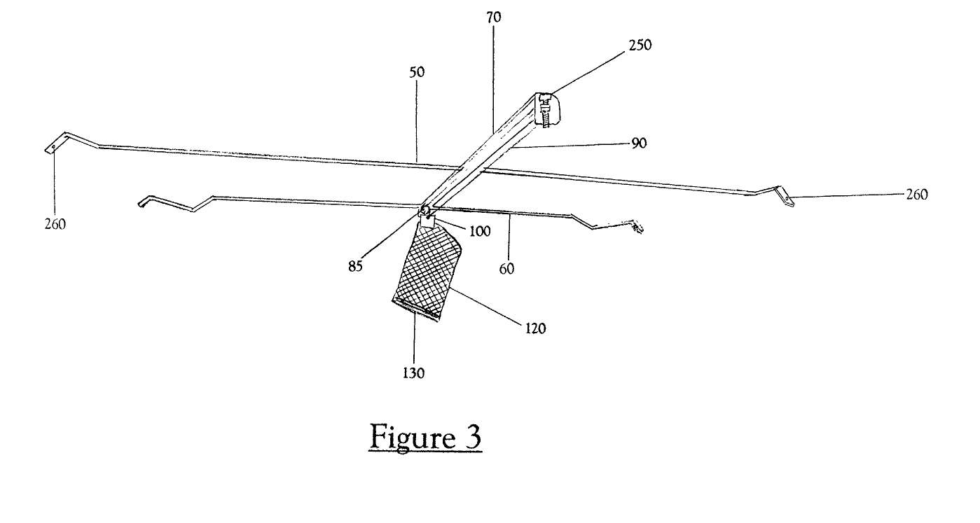

The best mode for carrying out the invention is presented in terms of its preferred embodiment as shown in FIGS. 1, 2, 3, 4 and 6.

1. Detailed Description of the Figures

Referring now to FIGS. 1,2,3,4 and 6, the preferred embodiment of the present invention comprises a conveyor frame 70 with front and rear cross members 50, 60 all of a generally flat bar configuration. The conveyor frame 70 and cross members 50, 60 configuration is designed to be positioned directly below the headliner 30 of mini vans, passenger vans, large sport utility vehicles and handicap accessible vehicles. Said front cross member 50 and said rear cross member 60 are configured parallel to each other and perpendicular to said conveyor frame 70.

A front pulley 80 and a rear pulley 85 are positioned on either end of conveyor frame 70. A retaining nut and bolt assembly 250 secures each pulley onto said conveyor frame 70. A nylon string 90 is looped around said front pulley 80 and said rear pulley 85. Said nylon string 90 is threaded through the small metal plate 100. Knots are tied on either side of said small metal plate 100 in order to secure said metal plate 100 in a fixed location on said nylon string 90. Both ends of said nylon string 90 are then fastened together with enough tension to allow both said front pulley 80 and said rear pulley 85 to work in unison to facilitate the overhead transportation of items along a horizontal plane parallel and in close proximity to said conveyor frame 70. Items are then transported just fore and aft of said conveyor frame 70. Mounting hole attachment sites 260 are located at each end of said front and rear cross members 50, 60 and used to attach the invention to a motor vehicle.

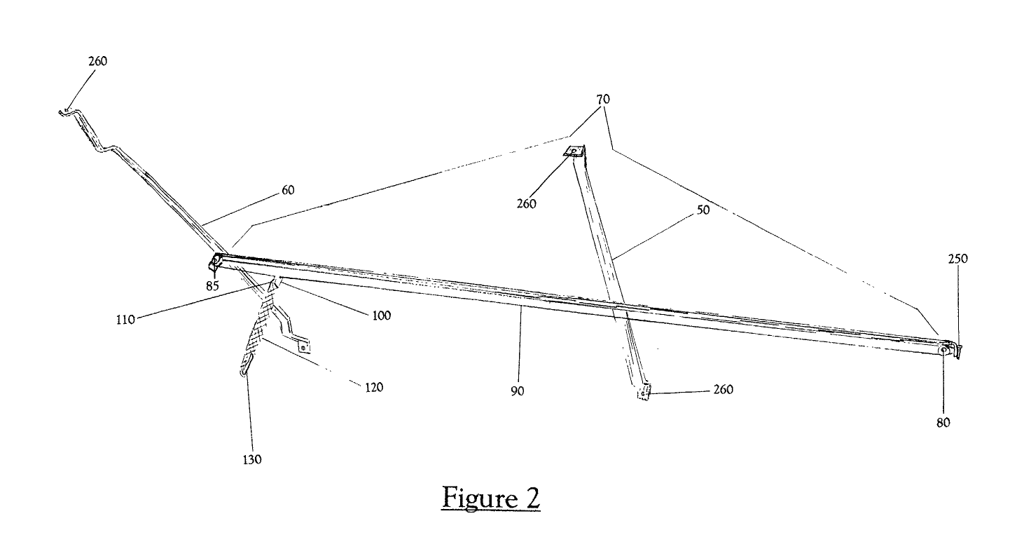

Referring now to FIGS. 2, 3 and 4, a nylon mesh shuttle bag 120 is temporarily secured to said metal plate 100 during transportation through a magnetic bond by utilizing a powerful magnet sewn inside of said bag 110. Items are secured inside of said nylon mesh bag 120 through the use of a Velcro closure 130. Said nylon mesh shuttle bag magnet 110 allows secure transport of said items and easy recovery of said items through a passenger simply pulling said nylon mesh shuttle bag 120 toward themselves (once item reaches its intended destination) thus breaking the magnetic bond between said metal plate 100 and said nylon mesh bag magnet 110

It is envisioned that other styles and configurations of the conveyor frame 70 and front and rear cross members 50, 60 can be easily incorporated into the teachings of the present invention, and only one particular configuration shall be shown and described for purposes of clarity and disclosure and not by way of limitation of scope.

It is envisioned that all the major components of the present invention be constructed of a strong, lightweight material, such as aluminum or plastic.

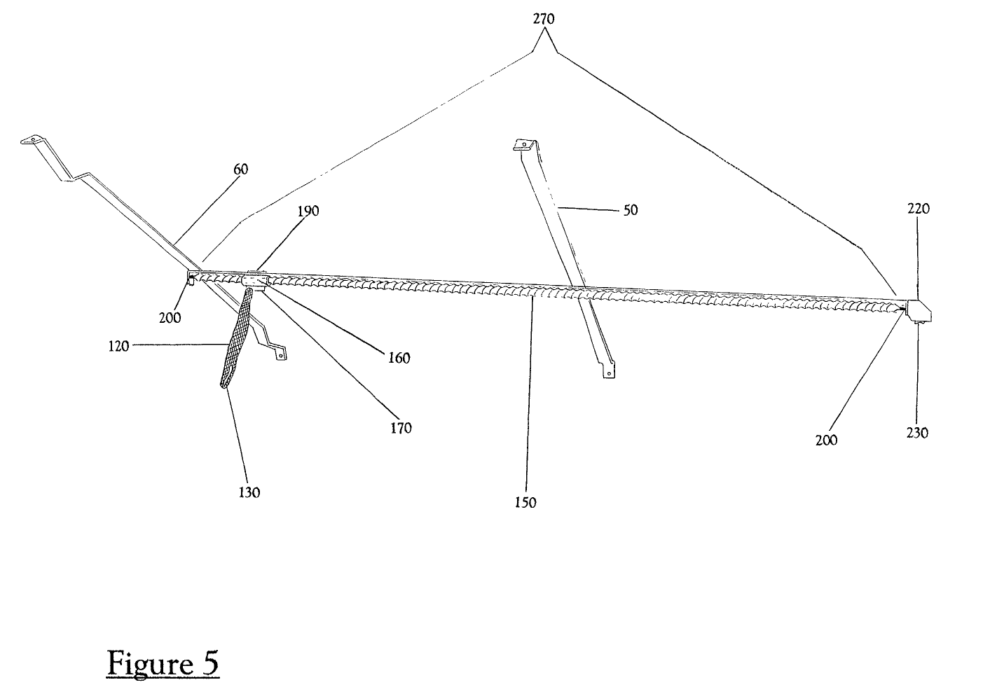

Referring now to FIG. 5, in an alternate embodiment of the present invention, a rotatable screw gear 150 is utilized in the transportation of items just fore and aft of the screw gear conveyor frame 270. The rotatable screw gear 150 is secured to the screw gear conveyor frame 270 by screw gear housings 200 which allow the screw gear 150 to freely rotate while remaining secured in said screw gear conveyor frame 270. Screw gear shuttle bolt 160 traverses the length of the rotatable screw gear 150 as it is rotated by the electric/battery powered screw gear motor 220. A metal shuttle bolt stabilizer 190 runs along a groove within the entire length of said screw gear conveyor frame 270 prohibiting the screw gear shuttle bolt 160 from rotating along with said rotatable screw gear 150.A magnetized metal plate 170 is permanently attached to said screw gear shuttle bolt 160. A three-position toggle switch 230 turns said electric/battery powered screw gear motor 220 off/forward/backward.

2. Operation of the Preferred Embodiment

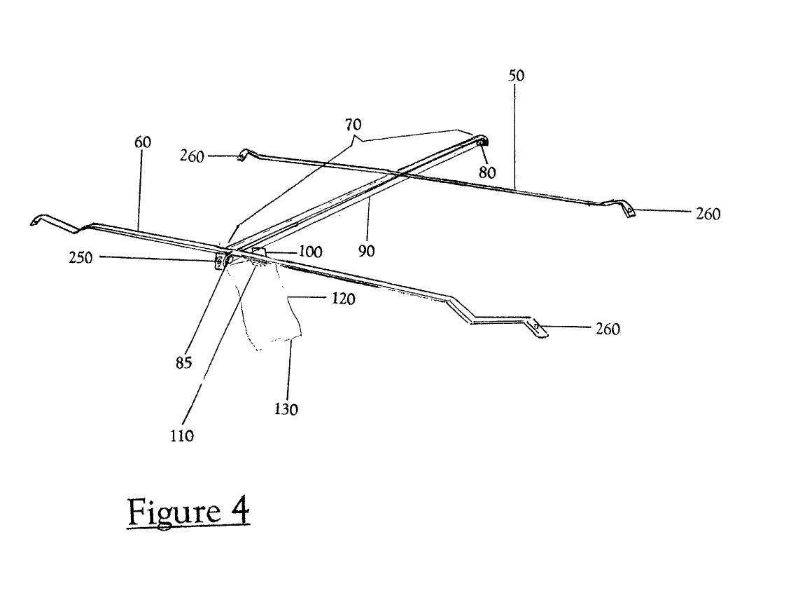

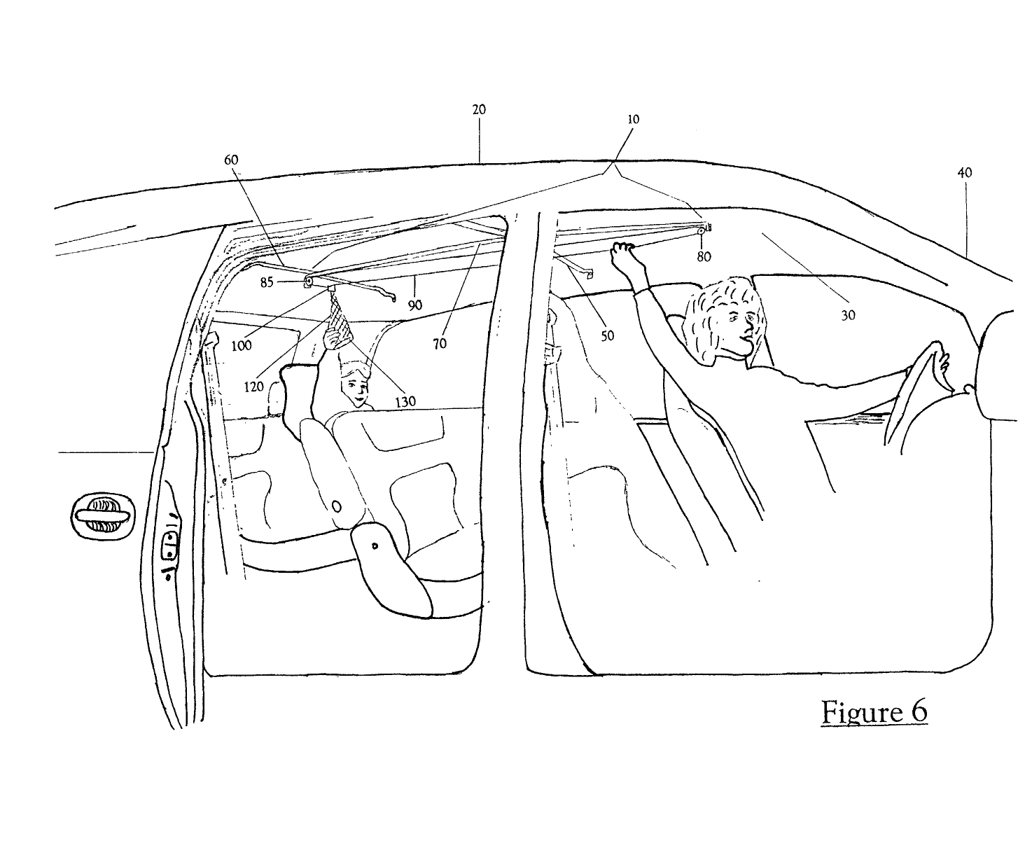

Referring now to FIGS. 4 and 6, to use the present invention to transport items between passengers, the operator should follow these steps: First, place the item inside of the nylon mesh shuttle bag 120 and close the Velcro closure 130. Second, attach the nylon mesh shuttle bag 120 to the small metal plate 100 of the conveyor frame 70 using the magnet sewn inside the bag 110. Third, the operator should manually transport the shuttle bag 120 (along with its contents) towards the intended passenger by pulling on the nylon string 90 until the nylon mesh bag 120 reaches the intended passenger. Fourth, the intended passenger should reach up to the nylon mesh bag 120 and tug on the nylon mesh bag 120 until the magnetic bond between the small metal plate 100 and magnet sewn inside the bag 110 is broken. Fifth, the intended passenger should then open the nylon mesh bag 120 and receive the transported items.

The foregoing description is included to illustrate the operation of the preferred embodiment and is not meant to limit the scope of the invention. The scope of the invention is to be limited only by the following claims.

What is claimed is:

1. A ceiling mounted delivery device for use inside of a motor vehicle designed to allow the safe, accurate, convenient and controlled delivery of items between passengers who are separated by distances greater than their physical reach using a conveyor frame supported by both a front and a rear cross member configuration, said conveyor frame and cross member configuration being designed to be positioned directly below the headliner of said motor vehicles, comprising:
a) said front cross member and said rear cross member both being constructed from one inch wide by one quarter inch thick flat metal, configured parallel to each other and perpendicular to said conveyor frame, said conveyor frame being positioned slightly off centerline of the motor vehicle's headliner and running generally fore and aft of said motor vehicle, said conveyor frame being supported by two cross members which attach to pre-existing mounting sites in said motor vehicle;
b) a front pulley and a rear pulley are attached to either end of said conveyor frame and secured at these points by metal nuts and bolts;
c) a nylon string is looped around said front pulley and rear pulley and threaded through a small metal plate;
d) knots are tied on either side of said small metal plate in order to secure said metal plate in a fixed location along a point on said nylon string, both ends of said nylon string are then fastened together with enough tension to allow both said front pulley and said rear pulley to work in unison to facilitate the overhead transportation of items along a horizontal plane parallel and in close proximity to the conveyor frame;
e) roller bearings are positioned inside pulleys to facilitate a smooth, controlled conveyor operation; and
f) mounting hole attachment sites are located at each end of said front and rear cross members and used to attach said invention to said motor vehicle.

2. The ceiling mounted delivery device of claim 1, wherein said delivery device further comprises:
a nylon mesh shuttle bag utilized to hold items while in transit, said nylon mesh shuttle bag is comprised of a Velcro closure at one end and a small powerful metal magnet sewn into the other end, thus allowing said nylon mesh shuttle bag to be secured to said conveyor frame via said metal plate.

3. The ceiling mounted delivery device of claim 2, wherein the purpose of the magnet sewn inside of the nylon mesh shuttle bag is to allow secure transport of said items along the length of said conveyor frame.

4. The ceiling mounted delivery device of claim 1, wherein said conveyor frame can also be supported by other means such as double sided tape applied to said motor vehicle headliner, Velcro tape applied to said conveyor frame and said headliner, a magnetized conveyor frame which bonds to the metal roof of said motor vehicle through said headliner, all of which allow easy mounting and installation inside of said motor vehicle.

5. The ceiling mounted delivery device of claim 2, wherein the purpose of said magnet sewn inside of nylon mesh shuttle bag is to allow the recipient of said nylon mesh bag to easily remove the nylon mesh bag from said conveyor frame by pulling said nylon mesh bag away from said conveyor frame thus breaking the magnetic bond between said metal plate and said magnet sewn inside of nylon mesh shuttle bag.

6. The ceiling mounted delivery device described in claim 1, wherein, a rotatable screw gear is utilized in the transportation of items along the length of the conveyor frame, the rotatable screw gear is secured to the conveyor frame by screw gear housings, which allow the screw gear to rotate, a screw gear shuttle bolt traverses the length of the rotatable screw gear as it is rotated by the screw gear motor, a metal shuttle bolt stabilizer runs along a groove within the entire length of the conveyor frame prohibiting said screw gear shuttle bolt from rotating and a magnetized metal plate is permanently attached to the screw gear shuttle bolt.

7. The ceiling mounted delivery device described in claim 1, wherein said conveyor frame, said cross members, said rotatable screw gear are constructed of a strong light weight material.

8. A method to transport items between passengers who are separated by distances greater than their physical reach using said ceiling mounted delivery device of claim 1, comprising the steps of:
a) placing the item inside of the nylon mesh shuttle bag and close the Velcro closure; attach the nylon mesh shuttle bag to the small metal plate of the conveyor frame using the magnet sewn inside the bag, and
b) transporting the shuttle bag with its contents to wards the intended passenger by pulling on the nylon string or engaging said electric/battery powered screw gear motor until the nylon mesh bag reaches the intended passenger

9. A method to receive items using said ceiling mounted delivery device of claim 1, comprising the steps of: reaching up to the nylon mesh bag and tugging on the nylon mesh bag until the magnetic bond between the small metal plate and magnet sewn inside the bag is broken, the intended passenger should then open the nylon mesh bag and retrieve the transported item(s).

10. The ceiling mounted delivery device of claim 1, wherein said delivery device is mounted next to said headliner of said motor vehicle thus placing invention in a convenient location that is also free of any obstructions and does not in any way obstruct normal activity within said motor vehicle.

11. The ceiling mounted delivery device of claim 6, wherein the rotatable screw gear is powered by an electric motor, which can be operated by driver of said motor vehicle or front seated passenger of said motor vehicle in forward, or reverse. A three-position toggle switch turns the screw gear motor off/forward/backward.

12. The ceiling mounted delivery device of claim 11, wherein the purpose of an electric/battery powered motor is to improve the operating efficiency, control and safety of invention.
